(19) United States
(12) Patent Application Publication
(10) Pub. No.: US 2002/0007933 A1
(43) Pub. Date: Jan. 24, 2002

(54) Heat exchanger arrangement on a front carrying structure of a motor vehicle

(76) Inventors: Karl-Heinz Baumann, Bondorf (DE); Ulrich Bruhnke, Ehningen (DE); Juergen Kohler, Aidlingen (DE); Uwe Krempels, Boeblingen (DE); Hansjoerg Schinke, Holzgerlingen (DE)

Correspondence Address: CROWELL & MORING LLP, Suite 700, 1200 G Street, N.W., Washington, DC, 20005, US

(21) Appl. No.: 09/854,919

(22) Filed: May 15, 2001

(30) Foreign Application Priority Data
May 15, 2000 (DE) DE 100 23 571.9

(51) Int. Cl. F28F 1/00; B60H 3/00; B61D 27/00; F28F 19/00

(52) U.S. Cl. 165/42; 165/134.1; 165/41

(57) ABSTRACT

A heat exchanger arrangement on a front carrying structure of a motor vehicle, with a passage orifice for the cooling-air stream which is largely overlapped by a heat exchanger module of the arrangement and which extends in a vehicle transverse plane and is delimited on two mutually opposite sides by wall regions of the carrying structure, the wall regions belong to the deformable zone of the forward structure. The heat exchanger module is mounted on the front carrying structure in such a way that, in the event of head-on collisions subjecting the region of the passage orifice to stress, said heat exchanger module, while absorbing impact energy, co-operates reinforcingly with the wall regions of the carrying structure.

### BACKGROUND AND SUMMARY OF THE INVENTION

This application claims the priority of German Application 100 23 571.9, filed May 15, 2000, the disclosure of which is expressly incorporated by reference herein.

The invention relates to a heat exchanger arrangement on a front carrying structure of a motor vehicle with a passage orifice for a cooling-air stream, which is overlapped largely by a heat exchanger module of the arrangement and which extends in a vehicle transverse plane and is delimited on two mutually opposite sides by wall regions of the carrying structure, the wall regions belonging to a deformable zone of the front carrying structure.

In a heat exchanger arrangement of this type, which is known from German Patent Document DE 30 24 312 A1, a passage orifice for a cooling-air stream is provided, which is cut out from a plane front wall extending in the transverse direction of the vehicle and is largely covered by a heat exchanger module. In this case, the heat exchanger module is mounted behind the front wall in a way not described in any more detail. Nor are any particulars given as to the behavior of the deformable zone in the event of a frontal impact.

An object of the invention is to develop further a heat exchanger arrangement of the type mentioned in the introduction, to the effect that the impact resistance of the wall regions adjacent to the passage orifice can be markedly improved.

This object is achieved according to the invention wherein the heat exchanger module is mounted on the front carrying structure in such a way that, in the event of a head-on collision subjecting a region of the passage orifice to stress, said heat exchanger module, while absorbing impact energy, cooperates reinforcingly with the wall regions of the carrying structure.

Advantageous further features of preferred embodiments of the invention may be gathered from the depending claims.

According to certain preferred embodiments of the invention, the heat exchanger module is mounted on the front carrying structure in such a way that, in the event of head-on collisions subjecting the region of the passage orifice to stress, the heat exchanger module co-operates reinforcingly with the wall regions of the carrying structure, while at the same time absorbing impact energy. As a result, the carrying structure, hitherto little suited to the absorption of accident energy in the region of the passage orifice, is significantly reinforced, and the load-distributing effect on the forward structure under frontally acting stress is markedly improved. For example, the heat exchanger arrangement can co-operate with the wall regions delimiting the passage orifice, in such a way that, by virtue of the arrangement, the impact forces in the event of a frontal impact with low width coverage can also be transmitted in the manner of a tie rod to the respective forward structure side which is not affected.

In certain preferred embodiments of the invention where the heat exchanger module projects at least partially beyond the passage orifice and with its end regions covers the wall regions delimiting the passage orifice, the module can be supported and/or fastened to other regions in a particularly stable manner in order to transmit high accident forces. Particularly good support of the heat exchanger module can be achieved, in this case, if the latter is arranged in front of the wall regions.

According to certain preferred embodiments of the invention, a large-size front wall has, in the event of a frontal impact, a very high flexural resistance and load-distributing effect over virtually the entire width and height of the forward structure. With the result, in the case of a frontal impact exerting a load on one side, the impact forces are conducted on to the respective forward structure side which is not affected.

According to certain preferred embodiments of the invention, the heat exchanger module can co-operate reinforcingly with the carrying structure particularly well in the manner of a tie rod if two of its end regions located opposite one another are fastened over their entire longitudinal extent to the wall regions of the carrying structure.

According to certain preferred embodiments of the invention, a heat exchanger module capable of being pushed into associated sliding guides in the manner of a drawer can not only be mounted in a simple way, but can also be fastened with the projecting end regions in a particularly stable manner in the region of the guide rails. In this case, a one-part construction of the extruded front wall and of the sliding guides has proved particularly cost-effective.

According to certain preferred embodiments of the invention, by way of further heat exchanger modules arranged in the region of overlap with the heat exchanger module, a space-saving arrangement suitable for transmitting even greater forces can be provided.

According to certain preferred embodiments of the invention, finally, the front wall can have mounted on it in a simple way further assemblies which are incorporated into the deformation sequence in the event of a frontal impact.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an oblique front and top perspective view of a carrying structure of a motor vehicle with a large-size front wall, out of which a passage orifice for the heat exchanger arrangement according to the invention is cut;

FIG. 2 shows an oblique front and top perspective view of the carrying structure according to FIG. 1 partially boarded over with trim parts;

FIG. 3 shows an exploded perspective illustration of the front wall, of a heat exchanger arrangement module capable of being pushed into sliding guides in the manner of a drawer and of a front module longitudinal leg capable of being pushed into sliding guides; and

FIG. 4 shows an enlarged section through the front wall and the heat exchanger arrangement arranged on the latter, along the line IV-IV in FIG. 3.

### DETAILED DESCRIPTION OF THE DRAWINGS

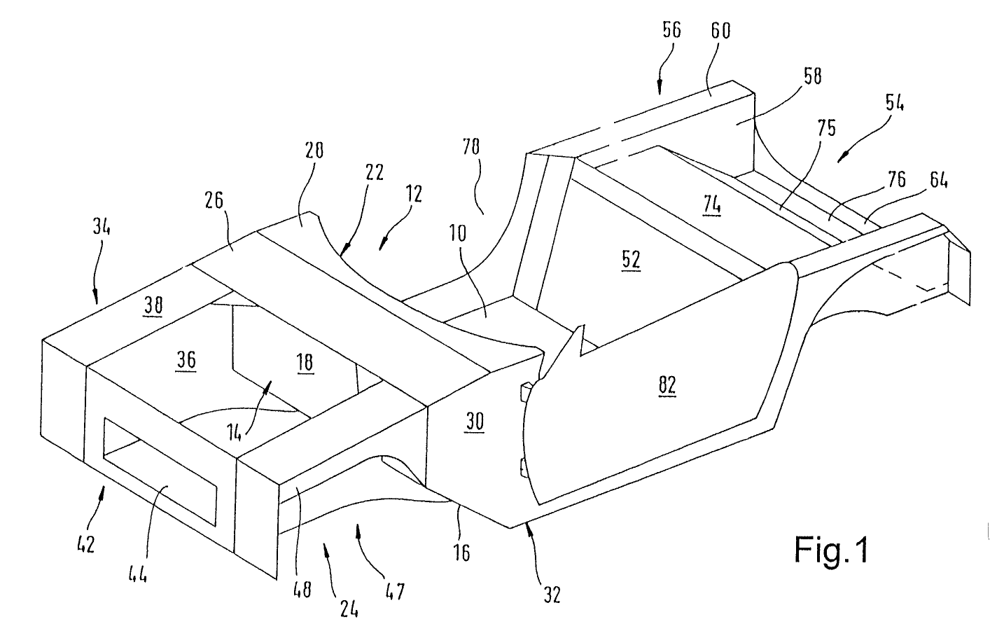

FIG. 1 illustrates an oblique front and top perspective view of a carrying structure of a motor vehicle, said carrying structure comprising a carrying floor 10 of lightweight construction. The carrying structure, described further, has predominantly energy-absorbing, inherently stable and plane lightweight panels which are preferably manufactured, depending on requirements, in a sandwich form of construction, with a honeycomb structure, in wood or in aluminum, as a composite fiber structure, as an extruded profile or the like. In order to achieve favorable manufacturing conditions, the individual panel sections may be both produced and angled in one part and assembled in a multi-part manner. At the front, in the leg room region 12, the floor 10 merges into a bulkhead 14 of lightweight construction which comprises a transitional region 16 adjoining the floor 10 and directed obliquely forwards and upwards and an approximately vertical region 18 arranged above the latter. The leg room region 12 is delimited laterally and at the top by a panel arrangement of lightweight construction which, together with the floor 10 and the bulkhead 14, forms a supporting box 22 for a forward structure 24 fastened to the latter. At the same time, the panel arrangement comprises a front and a rear upper lightweight panel 26, 28 and lateral supporting-box walls 30 which laterally delimit the leg room region 12 and in each case form a wall region of a side wall 32 of the carrying structure.

The forward structure 24 comprises two front side members 34 of lightweight construction, which each have an angled cross section with an approximately vertical panel leg 36 and a panel leg 38 running transversely to the latter. The vertical panel legs 36 are arranged so as to be offset inwards, in relation to the associated lateral supporting-box wall 30, in the direction of the longitudinal mid-plane and running approximately parallel to this. The panel leg 38 running in each case transversely projects laterally outwards from the associated vertical panel leg 36 approximately at right angles and extends as far as the associated side wall 32. The transversely running panel legs 38 adjoin with their rear ends the front upper lightweight panel 26 approximately level with the latter.

Fastened to the front end of the side members 34 is a front wall 42 which runs in the vehicle transverse direction and approximately vertically and which is made, here, of an extruded profile. This lightweight wall 42 is adapted, here, in height to the vertical panel leg 36 and in width to the supporting box 22. At the same time, the transversely running panel legs 38 of the side members 34 adjoin with their front ends the front wall 42 approximately level with the latter. The front wall 42, extending virtually over the entire width and height of the forward structure and having the heat exchanger arrangement described below, generates, by virtue of its flexural resistance, a load-distributing action and consequently a homogenous reaction force under frontally acting stress, such as during a frontal impact, over virtually the entire width and height of the forward structure 24. In other words, under the load of a frontal impact on one side, the front wall 42 not only ensures load distribution in the longitudinal direction, but also the impact forces are conducted in the manner of a tie rod to the respective forward structure side which is not affected. The lightweight panel 42, which may be produced both in one part and, as shown here, so as to be assembled in a multi-part manner, is provided with a passage orifice 44 for a cooling-air stream of a heat exchanger arrangement described below. The side walls 32 are prolonged forwards as far as the front wall 42 and are each provided with a wheel cut-out 47. The side wall 32 is therefore designed, over the predominant length of the associated side member 34, as a relatively narrow web 48 which is firmly connected to the transversely running panel leg 38 of the corresponding side member 34 approximately at right angles and also to the front wall 42. Overall, the vertical and the transversely running panel leg 36, 38, the narrow web 48, the bulkhead 14 and the front wall 42 form a front wheel case of the carrying structure.

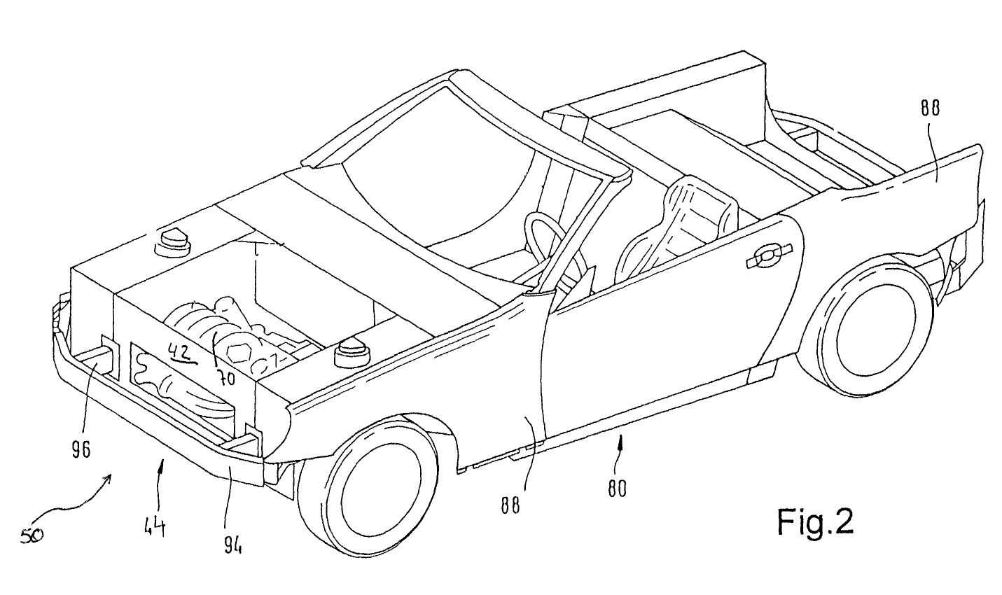

At the rear, the floor 10 merges into a rear partition 52 which projects obliquely rearwards and upwards and which is formed from a lightweight panel and extends between the side walls 32 over the entire width of the floor 10. The carrying structure has, behind the rear partition 52, a rear structure 54 with rear side members 56 comprised of lightweight panels which each have a panel leg 58 angled in the vehicle vertical direction and a panel leg 60 angled in the vehicle longitudinal direction. Fastened to the rear end of the rear side members 56 is a tailboard 64 which is of lightweight construction and runs in the vehicle transverse direction and approximately vertically. Overall, the vertical and the transversely running panel legs 58,60, the side wall 32, the rear partition 52 and the tailboard 64 form a rear wheel case of the carrying structure. The rear side members 56 are firmly connected to one another, via a panel arrangement comprising lightweight panels 74, 75, 76, to form a box. The side wall 32 has a door cut-out 78 for a side door 80 (FIG. 2), of which only a left-hand door inner wall 82 is illustrated here.

The carrying structure shown in a perspective view in FIG. 2 is arranged under boarding, of which trim parts 88 fixed to corresponding receptacles of the carrying structure and belonging to the right-hand front and rear mudguard are shown here. A diagrammatically indicated engine 70 is provided between the front side members 34, the heat exchanger arrangement not being illustrated here for the sake of clarity. A front module 50 can be seen additionally on the front side of the front wall 42 and comprises a crossmember 94 fixed to the lightweight panel via two longitudinal legs 96. In this case, crash boxes serving for absorbing energy in the event of a frontal impact may be integrated into the longitudinal legs 96.

In the case of a head-on accident, the carrying structure preferably has a deformation sequence, in which first the front module 50 together with the crossmember 94 and with the longitudinal legs 96 is deformed. In the event of a stronger impact, the forward structure 24 together with the front wall 42 and with the front side members 34 is then subjected to stress, the safety passenger cell as far as possible preserving its shape, even in the event of serious accidents. In other words, the front wall 42 separates the superficial damage region of the carrying structure from the deformable region for medium and high accident severity, that is to say the structural parts or components located in front of the front wall 42 can undergo deformation during a frontal impact, without the structure located behind them experiencing deformations. The deformation sequence may be achieved, for example, by the use of different materials or different panel thicknesses. The front side members 34 may have a front portion which can be replaced relatively simply in the event of a repair. The rearward structure 54 is preferably also designed according to the forward structure 24.

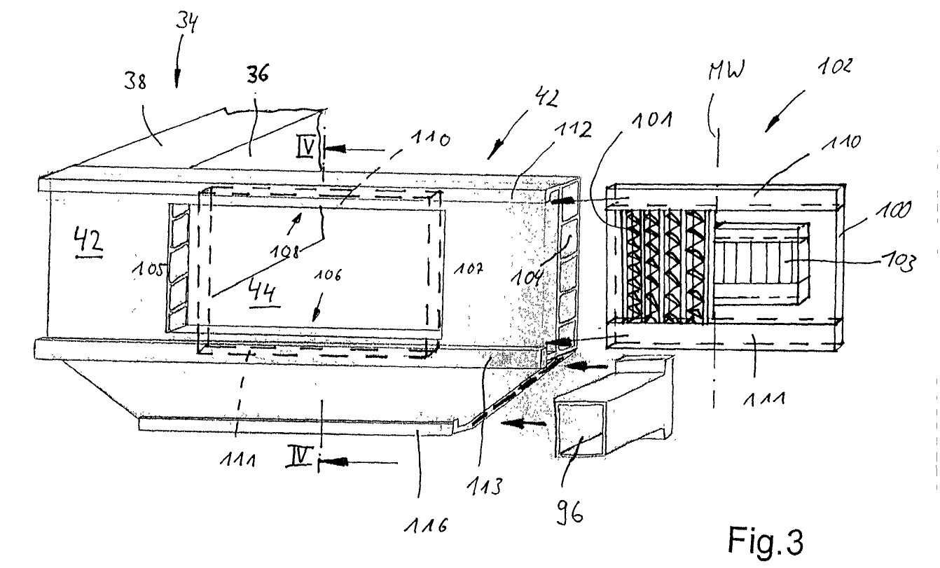

FIG. 3 shows an exploded perspective illustration of the front wall 42, of a heat exchanger module 100 capable of being pushed into sliding guides of the front wall 42 in the manner of a drawer and belonging to the heat exchanger arrangement 102 and of a longitudinal leg 96 of the front module 50, said longitudinal leg being capable of being pushed into sliding guides. The heat exchanger module 100 is assigned, here, to the cooling-water circuit of the engine 70. As seen from the front, a further module 103 fastened in front to the heat exchanger module 100 can be seen on the right of a vertically running center line MW of the heat exchanger arrangement 102. This further heat exchanger module 103 may be assigned, for example, to the oil circuit or to an air-conditioning system. It would also be conceivable to use the module 103 as a charge-air cooler. Cooling ribs 101 of the heat exchanger module 100, which run between an upper and a lower water box, can be seen on the left-hand side of the center line MW on which the module 103 is not illustrated. The further module 103 is located, overall, in the region of overlap of the module 100.

Of the side members 34 carrying the front wall 42 with their front ends, only the two panel legs 36, 38 of the right-hand side member 34 are indicated in FIG. 3. The chambers 104 of the front wall 42 produced from an extruded profile run in the vehicle transverse direction, the passage orifice 44 being cut out from the middle region of the wall 42. The passage orifice 44 is of approximately rectangular design and here is delimited on all four edge sides by wall regions 105-108 of the front wall 42. It would be conceivable, in this case, for the passage orifice 44 to be delimited only on two mutually opposite sides, here either laterally by then separate wall regions 105 and 107 or at the top and bottom by then separate wall regions 106 and 108 of the front wall 42, in which case the then separate wall regions 105 and 107 or 106 and 108 in each case located opposite one another could be firmly connected to one another via connecting members. In other words, it would therefore also be possible to have, for the passage orifice 44, a frame comprising at least two wall regions 105-108 of the carrying structure, in which case the two mutually opposite wall regions, together with said connecting members, could form the frame legs of the frame. The wall 42 tapers laterally at the bottom inwards in an approximately V-shaped manner, although a rectangular configuration of the front wall 42 would, of course, also be possible.

The heat exchanger module 100 of the heat exchanger arrangement 102 is dimensioned, here, such that it projects with an upper and a lower end region 110, 111 beyond the passage orifice 44.

As indicated by arrows, the heat exchanger module 100 is capable of being pushed with these projecting end regions 110, 111 in the manner of a drawer into associated sliding guides 112, 113 of the upper and the lower wall region 106, 108 of the front wall 42. The pushed-in position of the heat exchanger module 100 or of the heat exchanger arrangement 102 is indicated by broken lines, the heat exchanger module 100 being arranged in front of the passage orifice 44 in the exemplary embodiment shown here. In the pushed-in position, it is clear that the heat exchanger module 100, essentially overlapping the passage orifice 44, with its upper and lower end regions 110, 111 projects beyond the passage orifice 44 or at least partially overlaps the associated upper and lower wall regions 106, 108. It would be conceivable, in this respect, for the heat exchanger module 100 moreover to project laterally with its two lateral end regions beyond the passage orifice 44; it would also be possible for the heat exchanger module 100 to project beyond the passage orifice 44 solely with the lateral end regions, instead of with the upper and lower end regions 110, 111.

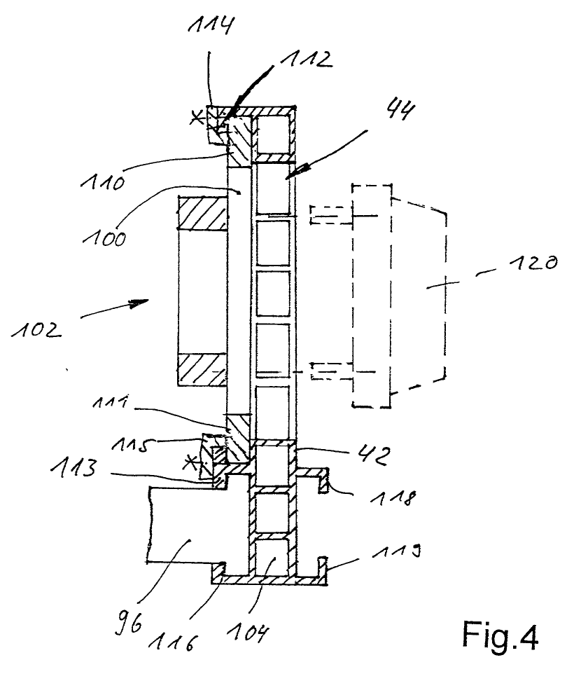

The one-part design of the sliding guides 112, 113 together with the front wall 42 can be seen in a comparison with FIG. 4 which shows an enlarged section along the line IV-IV in FIG. 3 through the front wall 42 and the heat exchanger arrangement 102 arranged in the pushed-in position. The upper sliding guide 112 is in cross section approximately L-shaped and the lower sliding guide 113 approximately T-shaped. The sliding guides 112, 113, running parallel to one another here, engage around the respectively associated upper and lower end regions 110, 111 along the edge over the entire longitudinal extent of the heat exchanger module 102, so that a movement of the module 100 in the vertical direction or in the vehicle longitudinal direction becomes impossible. In addition, here, the upper and lower end regions 110, 111 of the heat exchanger module 100 are fastened securely in position to the carrying structure in each case via an angular batten 114, 115 screwed to the associated sliding guide 112, 113. The module 100, could, of course, also be connected to the front wall 42 in another way, for example via straps. The angular battens 114, 115 run, here, over the entire longitudinal extent of the heat exchanger module 100. In other words, the heat exchanger module 100 is mounted on the front wall 42 of the carrying structure in such a way that, here, during head-on collisions subjecting the region of the passage orifice 44 to stress, said heat exchanger module, while absorbing impact energy, co-operates reinforcingly with the upper and lower wall regions 106, 108 of the front wall 42. In this case, it would, of course, also be conceivable for the heat exchanger module 100 to be pushed, for example, from above or below into vertical sliding guides arranged in the region of the wall regions 105 and 107, the heat exchanger module 100 then cooperating reinforcingly with the lateral wall regions 106, 108. If the heat exchanger module 100 is designed to overlap all four wall regions 105-108, it may also be fastened to all four wall regions 105-108.

Provided at the lower end of the front wall 42, so as to run parallel to one another and in the vehicle transverse direction, are sliding guides 113, 116, into which the longitudinal legs 96 of the front module 50 located in front of the front wall 42 can be pushed and fastened in the manner of the heat exchanger module 100, as indicated by arrows. In this case, only that of the two longitudinal legs 96 which is on the right, as seen from the front, is shown. As shown in FIG. 4, further sliding guides 118, 119 may also be provided on the rear side of the front wall 42 and serve for mounting a further heat exchanger module, not shown, or another assembly. FIG. 4 also indicates by broken lines a fan device 120 which may be fastened, for example via a screw connection, to the rear side of the module 100 or the front wall 42. Instead of the fan device 120 or the module 103, other modules, such as, for example, a condenser or engine bonnet lock, may also be used.

The sliding guides 112, 113 may also be designed as dovetail guides, to the cross section of which the associated end regions 110, 111 of the heat exchanger module 100 are adapted. A positive connection of particularly high tensile strength is thereby made between the corresponding wall regions 105-108 and the heat exchanger module 100. Moreover, it would also be conceivable to arrange the heat exchanger module 100 behind the front wall 42 or in the plane of the latter.

At least the heat exchanger module 100 is designed, here, as a so-called all-aluminum radiator which can absorb impact energy particularly effectively. In this case, both the water boxes in the upper and lower end regions 110, 111 of the module 100 and the pipes connecting these are produced from an aluminum alloy and are connected to one another in such a way that the radiator 100 is suitable for absorbing and equalizing high deformation forces. The further modules arranged in the region of overlap of the heat exchanger module 100 may likewise be designed in the manner of the above-described radiator and contribute to further increasing the energy absorption capacity of the entire heat exchanger arrangement 102.

Instead of the carrying structure described here, consisting of plane lightweight panels, it is, of course, also possible to use a carrying structure in a currently conventional body-shell or frame construction, the forward structure of which comprises at least the wall regions delimiting the passage orifice on two mutually opposite sides.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Heat exchanger arrangement on a front carrying structure of a motor vehicle, with a passage orifice for a cooling-air stream, which is overlapped largely by a heat exchanger module of the arrangement and which extends in a vehicle transverse plane and is delimited on two mutually opposite sides by wall regions of the carrying structure, the wall regions belonging to a deformable zone of the front carrying structure, wherein the heat exchange module is mounted on the front carrying structure in such a way that, in the event of a head-on collision subjecting a region of the passage orifice to stress, said heat exchanger module, while absorbing impact energy, co-operates reinforcingly with the wall regions of the carrying structure.

2. Heat exchanger arrangement according to claim 1, wherein the heat exchanger module is arranged in front of the passage orifice and projects with at least two opposite end regions beyond the passage orifice.

3. Heat exchanger arrangement according to claim 2, wherein the passage orifice is delimited at the top and bottom by the wall regions of the carrying structure, and in that the wall regions are overlapped at least partially by the upper and lower end regions of the heat exchanger module.

4. Heat exchanger arrangement according to claim 1, wherein the front carrying structure comprises a large-size front wall, out of a middle region of which the passage orifice is cut.

5. Heat exchanger arrangement according to claim 4, wherein the front wall is a lightweight wall of an extruded profile.

6. Heat exchanger arrangement according to claim 1, wherein two mutually opposite end regions of the heat exchanger module are fastened to the carrying structure approximately over an entire longitudinal extent of the end regions.

7. Heat exchanger arrangement according to claim 2, wherein the heat exchanger module is capable of being pushed with the projecting end regions in a manner of a drawer into associated sliding guides of the wall regions and of being secured in a pushed-in position via fixing elements.

8. Heat exchanger arrangement according to claim 7, wherein the sliding guides are produced in one part with a front wall.

9. Heat exchanger arrangement according to claim 1, wherein the heat exchanger module is assigned to a cooling-water circuit of an engine, and in that at least one further heat exchanger module is arranged in a region of overlap with the heat exchanger module.

10. Heat exchanger arrangement according to claim 4, wherein further assemblies are mounted on the front wall.

11. Heat exchanger arrangement according to claim 10, wherein the further assemblies is a front module arranged in front of the front wall.

12. Heat exchanger arrangement according to claim 7, wherein the proximity end regions and the associated sliding guides form a tongue and groove arrangement.

13. A heat exchanger assembly on a front carrying structure of a motor vehicle, comprising:
a passage orifice for a cooling-air flow extending in a transverse plane,
a heat exchanger module approximately overlapping the passage orifice, and
a front wall region of the front carrying structure having at least two mutually facing side wall regions delimiting the passage orifice,
wherein the heat exchanger module has two mutually opposite end regions operatively connected to the front wall region so that the front wall region and the heat exchanger modules belong to a deformable zone of the front carrying structure and reinforcingly cooperate with each other in the event of a head-on collision.

14. The heat exchanger assembly according to claim 13, wherein the heat exchanger module is arranged in the front wall region by sliding the two mutually opposite end regions into associated sliding guides of the front wall region and is secured with fixing devices.

15. A vehicle assembly comprising:
a front carrying structure of a motor vehicle having a passage orifice extending in a transverse plane for a cooling-air flow, and a deformable zone having wall regions which delimit the passage orifice on two mutually opposite sides, and
a heat exchanger module mounted on the front carrying structure substantially overlapping the passage orifice to thereby absorb impact energy and reinforcingly cooperate with the wall regions in the event of a head-on collision.

16. The assembly according to claim 15, wherein at least two opposite end regions of the heat exchanger module project beyond the passage orifice.

17. A method of making a motor vehicle assembly, comprising:
providing a front carrying structure with a passage orifice extending in a vehicle transverse plane,
delimiting the passage orifice on two mutually opposite sides by wall regions of the carrying structure, said wall regions being part of a deformable zone of the carrying structure, and
mounting a heat exchanger module on the carrying structure to substantially overlap the passage orifice so that, in the event of a head-on collision subjecting a region of the passage orifice to stress, said heat exchanger module absorbs impact energy and cooperates reinforcingly with the wall regions.

18. The method according to claim 17, wherein two mutually opposite end regions of the heat exchanger module are fastened to the carrying structure substantially over an entire longitudinal extent of the end regions.

19. A method of making a heat exchanger assembly on a front carrying structure of a motor vehicle, comprising:
providing a passage orifice for a cooling-air flow which extends in a vehicle transverse plane and is delimited on two mutually opposite sides by wall regions of a deformable zone of the front carrying structure,
providing a heat exchanger module with two opposite end regions, and
mounting the heat exchanger module approximately overlapping the passage orifice by arranging the end regions projecting beyond the passage orifice so that, in the event of a head-on collision, the heat exchanger module absorbs impact energy and cooperates reinforcingly with the wall regions.
